(19) United States
(12) Patent Application Publication
(10) Pub. No.: US 2006/0224514 A1
(43) Pub. Date: Oct. 5, 2006

(54) Method and system for managing web profile information

(75) Inventors: Giovanni Buschi, Nice (FR); Beatrice Coulomb, Cagnes sur Mer (FR); Dimitris Gibault, Cagnes sur mer (FR); Christophe Palaysi, Villeneuve-Loubet (FR)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/393,926

(22) Filed: Mar. 30, 2006

(30) Foreign Application Priority Data
Mar. 31, 2005 (EP) 05368010.4

(51) Int. Cl. G06Q 99/00

(52) U.S. Cl. 705/50

(57) ABSTRACT

A method and system for providing, storing and managing a user profile. A user profile is originally stored in a central storage repository which can then be accessed by many different providers. After appropriate authentication the user profile can then be downloaded to the provider sites. This means a user does not have to enter their details many times when accessing and using different providers.

### FIELD OF THE INVENTION

The present invention is directed to web profile information, and more particularly to a method and system for managing web profile information.

### BACKGROUND ART

Whenever a user accesses a web page it is generally necessary to complete certain registration information. This information may include name, address, birth date, e-mail details et cetera. Usually each web site has a slightly different registration form and each time it is necessary to manually fill in the form.

As the user may fill in many registrations it is possible that the user will lose track of some or all of the registration details. In addition, if the user changes any details it is necessary to remember all the registrations and correct the information on each.

### SUMMARY OF THE INVENTION

One object of the present invention is to overcome at least some of the problems associated with the prior art and provide a method and system for managing web profile information.

More particularly the present invention discloses a method of managing web profile information comprising the steps of:

storing a user profile on a central storage repository,

providing web access to the central storage repository from a provider site,

authenticating a connection between the provider site and the central storage repository in which the provider site requests a download of the user profile, and

downloading the user profile to the provider site.

More particularly the present invention discloses a system of managing web profile information comprising:

a system for storing a user profile on a central storage repository,

a system for providing web access to the central storage repository from a provider site,

a system for authenticating a connection between the provider site and the central storage repository in which the provider site requests a download of the user profile, and

a system for downloading the user profile to the provider site.

Advantages of the present invention are set out below. The user needs only add profile information once at a central storage location. This avoids the need for multiple and repetitive entry of information. In addition, if the user needs to change any profile information it is merely necessary to connect to the central storage location and update that rather than a multitude of individual locations such as merchant sites etc.

### BRIEF DESCRIPTION OF THE DRAWINGS

Reference will now be made, by way of example, to the accompanying drawings, in which:

FIG. 1 is a diagram showing how a user profile is created in accordance with the present invention.

FIG. 2 is a diagram showing user profile retrieval by a third party.

FIG. 3 is a diagram showing a web profile update process.

FIG. 4 is a flow chart showing the method of the present invention.

### DETAILED DESCRIPTION OF THE INVENTION

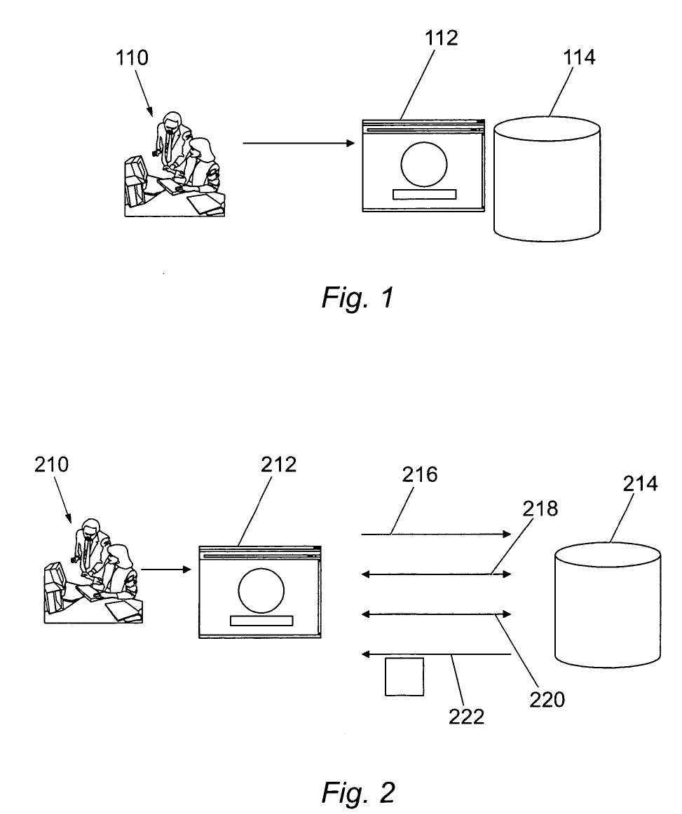

Referring initially to FIG. 1, a web user 110 is connected via appropriate means (not shown) to a web page 112. The web page 112 is that of a profile provider 114. The web user 110 connects to the web page 112 in order to either enroll and create a profile, update and maintain a profile, or delete a profile.

The first time the web user 110 accesses the web page 112 it will be necessary to enroll and create a user profile. This will involve entering personal data as identified below including setting up a login identification (ID) and a password.

At subsequent visits to the web page 112 it will be necessary to always enter the login ID and the password before access is given to the user profile. The user profile can then be easily amended or deleted as appropriate by the web user 110.

The personal data entered by the web user 110 will include the following list, which is by way of example only and may include more or less data as appropriate. Some of the data may be essential and some may be optional.

The data may include the following:

Name

Address

Telephone Number

Mobile Number

Fax Number

E-mail

Gender

Age

Date of birth

Authentication information (the purpose of this is described in further detail below)

Security questions and answers

Bank or credit card details

Possible delivery addresses

Demographic information

Interests/hobbies etc

The user profile may not always relate to a customer, but may relate to an object for example a car. In this case car details may be stored and used to populate an insurance provider's profile form and a garage profile form. An individual may have a user profile which includes different sections which can individually or in combination be used to populate a provider profile form.

Once the web user 110 has set up the user profile, the user profile may only be accessed by the web user 110 using the login and password; an administrator if the web user 110 loses the login and/or password; and a merchant web site (details to be described below). If the administrator needs to access the profile the web user 110 will be asked a number of questions including certain security questions, as is well known in the art.

Referring now to FIG. 2, the web user 210 (same as web user 110, FIG. 1) accesses a merchant web site 212 with the intention of purchasing something. The merchant web site 212 has an ability to link to the profile provider 214 (same as profile provider 114, FIG. 1), but can only receive information from the profile provider 214 if certain conditions are met.

The web user 210 makes a profile retrieval request 216 through a selection on the merchant web site 212. The merchant web site 212 may have an optional merchant authentication process 218 which links the merchant web site 212 to certain information at the profile provider 214. There will also be an authentication process 220 for the web user 210 which requires an entry of one or more of a login ID; a password; authentication information; a security question and answers, etc.

Once the authentication process or processes have been successfully completed, the user profile 224 is transferred 222 from the profile provider 214 to the merchant web site 212. The user profile 224 can then be used to populate the profile requirements of the merchant web site 212. The profile information is thus provided to the merchant web site 212 without any data entry from the web user 210. A record is maintained at the profile provider 214 of all merchant web sites 212 which have a certain user profile 224.

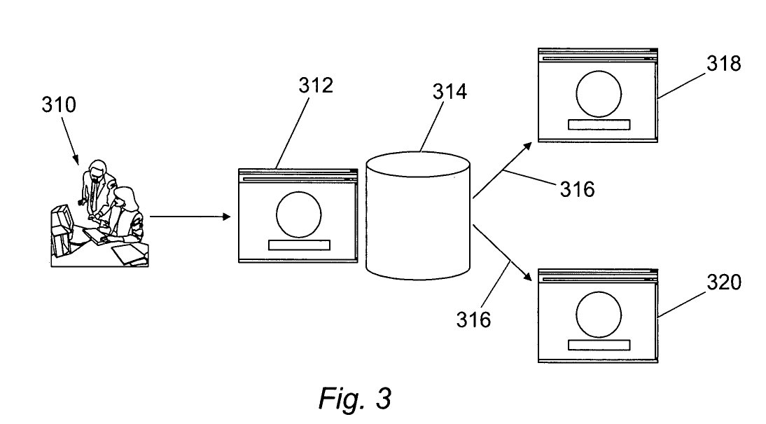

Referring now to FIG. 3, an update mechanism is now described. If the web user 310 (same as web user 110 (FIG. 1) and 210 (FIG. 2)) wishes to update some or all of their user profile, i.e., a new address, bank detail, etc., the web user 310 need only connect to the web page 312 (same as web page 112, FIG. 1) of the profile provider 314 (same as profile provider 114 (FIG. 1) and 214 (FIG. 2)). At the web page 312, after appropriate user authentication, the web user 310 may update the profile information. This information is then sent 316 from the profile provider 314 to each merchant web site 318 and 320 in FIG. 3. The updates will be sent to as many live merchant web sites as are known to have previously received the given user profile. If the user has accessed the profile provider 314 to delete the user profile, the update to the merchant web sites may include either a request to delete the user profile or an update of the user profile with empty fields.

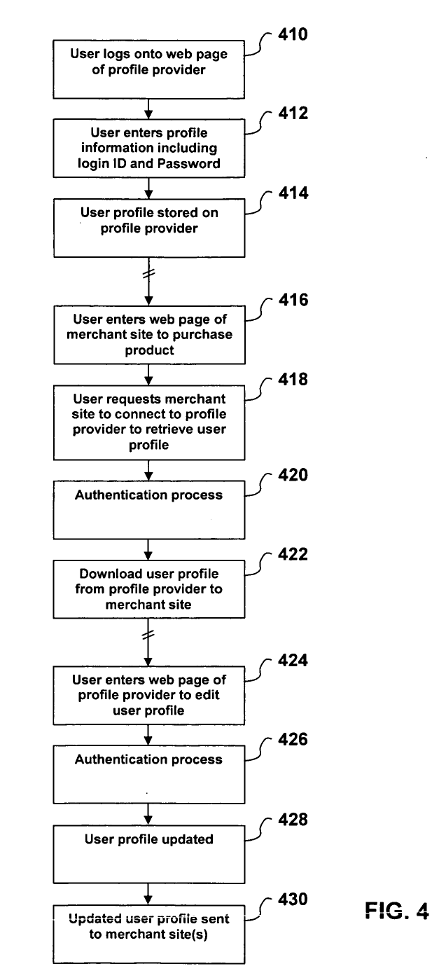

Referring now to FIG. 4 the steps that occur in the present invention are now described. A web user logs onto a web page belonging to a profile provider, step 410.

The web user then enters profile information including login and password details on the web page, step 412. This creates a user profile which is stored on the profile provider server step 414.

At a later time the user enters a web page of a merchant site in order to purchase a product, step 416. The user requests the merchant site to connect to the profile provider to retrieve user profile information, step 418. An authentication process occurs between the merchant site and the profile provider (optional) and between the user and the profile provider via the merchant site, step 420. Once authentication has been confirmed the user profile is downloaded from profile provider to the merchant site, without the user needing to enter the information in the user profile of the merchant site, step 422.

At a still later time (maybe many months or more) the user may re-enter the profile provider web page to make changes to the user profile, step 424. Authentication process occurs, step 426 and then the user profile is updated, step 428. The updated user profile is then sent to any merchant site which has previously had the user profile, step 430. Obviously an appropriate authentication process is included in step 430. The present invention has been described in the context of web pages but may equally apply to any place where a user may be required to enter profile information, e.g., a phone or other pda device connected to a provider of some sort. The provider may not be a merchant, but may instead be another type of provider, e.g., services, information storage, etc.

While the invention has been particularly shown and described with reference to a preferred embodiment, it will be understood that various changes in form and detail may be made therein without departing from the spirit and the scope of the invention.

1. A method of managing web profile information comprising the steps of:
storing a user profile on a central storage repository,
providing web access to the central storage repository from a provider site,
authenticating a connection between the provider site and the central storage repository in which the provider site requests a download of the user profile, and
downloading the user profile to the provider site.

2. The method of claim 1, wherein the step of authenticating the connection comprises entering user authentication data via the provider site to authenticate the provider site with respect to the user.

3. The method of claim 1, further comprising providing profile information in the user profile in a form of a plurality of pieces of personal information.

4. The method of claim 1, wherein the downloading step comprises downloading the user profile to the provider site to populate a provider site user profile.

5. The method of claim 1, further comprising updating the user profile via access to the central storage repository and sending the updated user profile to the provider site.

6. The method of claim 1, further comprising authenticating a connection between a plurality of provider sites and the central storage repository to allow download of the user profile to all authenticated provider sites.

7. The method of claim 1, wherein the authenticating step comprises:
at a first access to the central storage repository entering a user identification and a password; storing the user identification and the password at the central storage repository; and
at a later access to the central storage repository entering an entered user identification and an entered password via either the provider site or directly comparing the entered user identification and password with the user identification and the password stored at the central repository.

8. A system of managing web profile information comprising:
a system for storing a user profile on a central storage repository,
a system for providing web access to the central storage repository from a provider site,
a system for authenticating a connection between the provider site and the central storage repository in which the provider site requests a download of the user profile, and
a system for downloading the user profile to the provider site.

9. The system of claim 8, wherein the authenticating system further includes a system for entering user authentication data via the provider site to authenticate the provider site with respect to the user.

10. The system of claim 8, further comprising a system for providing profile information in the user profile in a form of a plurality of pieces of personal information.

11. The system of claim 8, wherein the system for downloading further comprises a system for downloading the user profile to the provider site to populate a provider site user profile.

12. The system of claim 8, further comprising a system for updating the user profile via access to the central storage repository and a system for sending the updated user profile to the provider site.

13. The system of claim 8, further comprising a system for authenticating a connection between a plurality of provider sites and the central storage repository to allow download of the user profile to all authenticated provider sites.

14. The system of claim 8, wherein the system for authenticating further comprises:
a system for entering a user identification and a password at a first access to the central storage repository; a system for storing the user identification and the password at the central storage repository; and
a system for entering an entered user identification and an entered password at a later access to the central storage repository via either the provider site or for directly comparing the entered user identification and password with the user identification and the password stored at the central repository.
